(19) United States
(12) Patent Application Publication
(10) Pub. No.: US 2010/0311389 A1
(43) Pub. Date: Dec. 9, 2010

(54) WIRELESS COMMUNICATION SERVICE SYSTEM AND TRANSMISSION METHOD THEREOF, AND MOBILE PHONE AND DIALING METHOD UTILIZING THE SYSTEM

(75) Inventor: Kui-Jun Wang, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (SheZhen) CO., LTD., Shenzhen City (CN); HON HAI PRECISION INDUSTRY CO., LTD., Tu-Cheng (TW)

(21) Appl. No.: 12/547,488

(22) Filed: Aug. 26, 2009

(30) Foreign Application Priority Data
Jun. 4, 2009 (CN) 200910302924.6

(51) Int. Cl. H04M 15/00; H04W 40/00

(52) U.S. Cl. 455/406; 455/445

(57) ABSTRACT

A wireless communication service system and a mobile phone are provided. The mobile phone generates a calling signal of a recipient number and determines whether a storage unit has stored a cornet associated with the recipient number. If the storage unit has stored the cornet, the mobile phone sends a transmission containing the cornet. If the storage unit has not stored the cornet, the mobile phone sends a transmission containing the recipient number. When the wireless communication service system receives the transmission containing the recipient number, the wireless communication service system determines whether the recipient number has joined a cornet cluster network of a caller number. If so, the wireless communication service system calls the cornet. If not, the wireless communication service system calls the recipient number.

### BACKGROUND

1. Technical Field

The disclosure relates to wireless communication technologies and, more particularly, to a wireless communication service system and a transmission method and a mobile phone and a dialing method using the system.

2. Description of the Related Art

In mobile telecommunications, when a caller of a mobile phone calls a recipient having another mobile phone, both the caller and the recipient must pay call charges. Some service providers promote a cornet cluster network for phone customers, building a dedicated virtual network and performing a unified code and group network for each cornet cluster network. Each customer in a cornet cluster network will be assigned a 3-6 digit cornet, pay a predetermined rate monthly, and place and receive calls for no additional charge. However, if a user is unaware of a cornet for a destination number, they remain ineligible to participate in the system.

### BRIEF DESCRIPTION OF THE DRAWINGS

The components in the drawings are not necessarily drawn to scale, the emphasis instead being placed upon clearly illustrating the principles of the wireless communication service system and the mobile phone. Moreover, in the drawings, like reference numerals designate corresponding parts throughout the several views.

FIG. 1 is a schematic view of communication between a mobile phone and a wireless communication service system according to an embodiment.

FIG. 2 is a block diagram of a mobile phone according to an embodiment, used in a wireless communication service system such as, for example, that of FIG. 1.

FIG. 3 is a flowchart of a dialing method according to an embodiment, employed by a mobile phone such as, for example, that of FIG. 2.

FIG. 4 is a flowchart of a transmission method according to an embodiment, used in the wireless communication service system such as, for example, that of FIG. 1.

### DETAILED DESCRIPTION

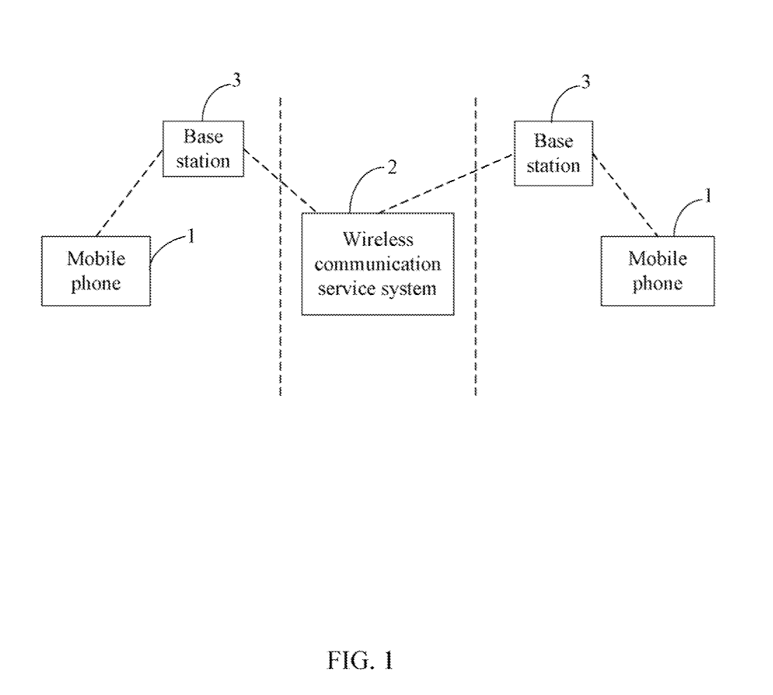

FIG. 1 is a schematic view of communication between a mobile phone and a wireless communication service system according to an embodiment. A wireless communication service system 2 provides service for mobile phones 1 via base stations 3. The wireless communication service system 2 processes communication data, controls data transmission, and accounts call charges for usage by the mobile phones 1. The wireless communication service system 2 includes a plurality of cornet cluster networks and a charge subsystem. Each cornet cluster network is assigned a defined code. The wireless communication service system 2 lists phone numbers of the mobile phones 1 and associated cornets in each cornet cluster network.

The charge subsystem is configured for accounting call charges of all mobile phones 1 thereof. The charge subsystem includes a cornet charge operation and a standard charge operation. The cornet charge operation provides service for cornet customers. The standard charge operation provides service for standard customers. Both a caller and a recipient prepay a first predetermined charge monthly for free use of the cornet charge operation, and the standard charge operation levies charges based on a call time such as a second predetermined charge per minute for each party.

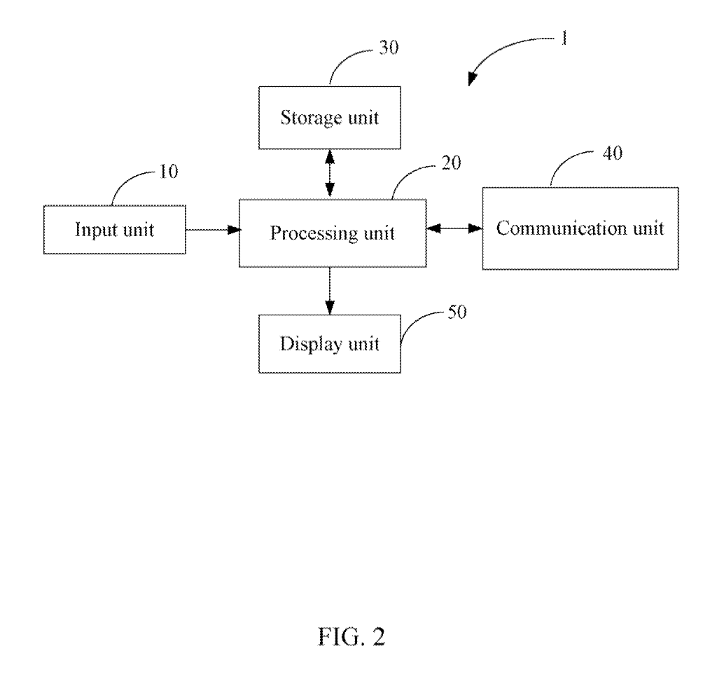

FIG. 2 is a block diagram of a mobile phone according to an embodiment, used in a wireless communication service system such as, for example, that of FIG. 1. A phone number of the mobile phone 1 (hereinafter “caller number”) is part of a cornet cluster network of the wireless communication service system 2 and the mobile phone 1 owns a cornet in the cornet cluster network. The mobile phone 1 includes an input unit 10, a processing unit 20, a storage unit 30, a communication unit 40, and a display unit 50. The storage unit 30 stores at least one phone number of another mobile phone 1 (hereinafter “recipient number”) and an associated cornet in the cornet cluster network corresponding to the recipient number. For example, a recipient number is “137______” and a cornet is “66______” corresponding to the recipient number. The display unit 50 is configured for displaying information.

The input unit 10 is configured for generating a calling signal of a recipient number in response to user input. The communication unit 40 is configured for communicating with the wireless communication service system 2. The processing unit 20 is configured for determining whether the storage unit 30 stores a cornet corresponding to the recipient number based on the calling signal from the input unit 10. If the storage unit 30 stores an associated cornet, the processing unit 20 acquires the associated cornet and directs the communication unit 40 to transmit the cornet. The wireless communication service system 2 processes the cornet transmission, calls the cornet corresponding to the recipient number, and establishes a communication link with the recipient. Each party is now able to continue the call for free.

If the storage unit 30 has not stored an associated cornet, the processing unit 20 directs the communication unit 40 to transmit the recipient number. The wireless communication service system 2 processes the recipient number transmission and determines whether the recipient number has joined the cornet cluster network of the caller number. If the recipient number has not joined the cornet cluster network of the caller number, the wireless communication service system 2 calls the recipient number and establishes a communication link with the recipient, and the charge subsystem accounts call charges based on the standard charge operation for each party.

If the recipient number has joined the cornet cluster network of the caller number, that is, there is a cornet corresponding to the recipient number in the cornet cluster network of the caller number, the wireless communication service system 2 acquires the associated cornet, calls the cornet of the recipient number and establishes a communication link with the recipient. Each party can now participate in the call for free.

The wireless communication service system 2 further sends a transmission containing the cornet of the recipient number to the communication unit 40. The processing unit 20 processes the cornet transmission of the recipient number and acquires the cornet of the recipient number, stores the recipient number and the associated cornet in the storage unit 30, and directs the display unit 50 to display the cornet of the recipient number.

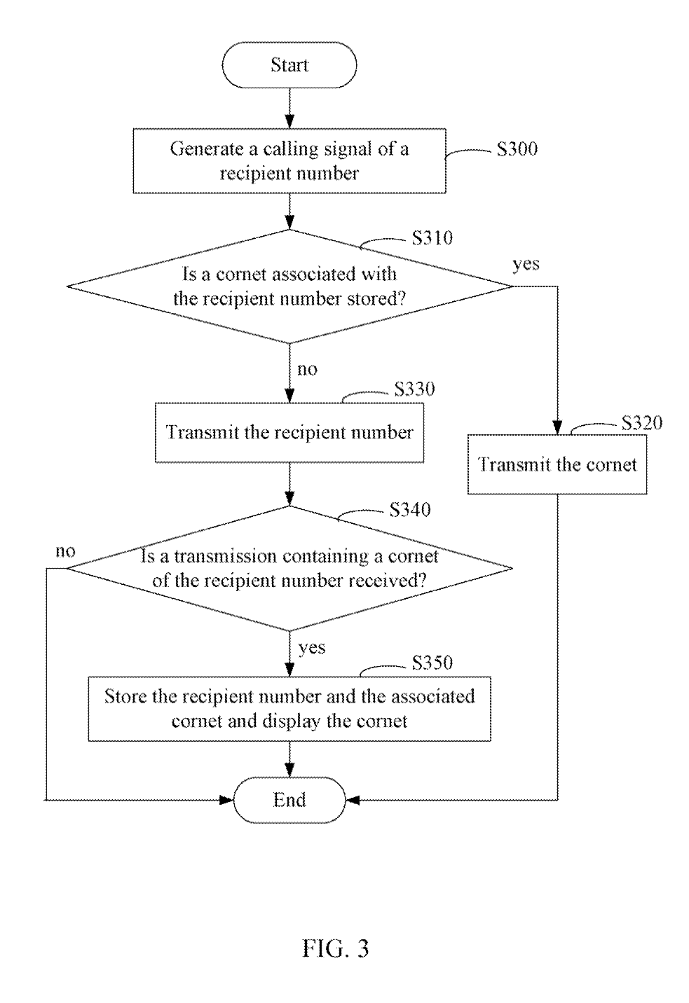

FIG. 3 is a flowchart of a dialing method according to an embodiment, employed by a mobile phone such as, for example, that of FIG. 2. In step S300, the input unit 10 generates a calling signal of a recipient number in response to user input. In step S310, the processing unit 20 determines whether the storage unit 30 has a cornet corresponding to the recipient number. If so, in step S320, the processing unit 20 acquires the associated cornet and directs the communication unit 40 to transmit the cornet.

If not, in step S330, the processing unit 20 directs the communication unit 40 to transmit the recipient number. In step S340, the processing unit 20 determines whether the communication unit 40 has received a transmission containing a cornet of the recipient number from the wireless communication service system 2. If not, the process is complete. If so, in step S350, the processing unit 20 acquires the cornet of the recipient number, stores the recipient number and the associated cornet in the storage unit 30, and directs the display unit 50 to display the cornet of the recipient number, and the process is complete.

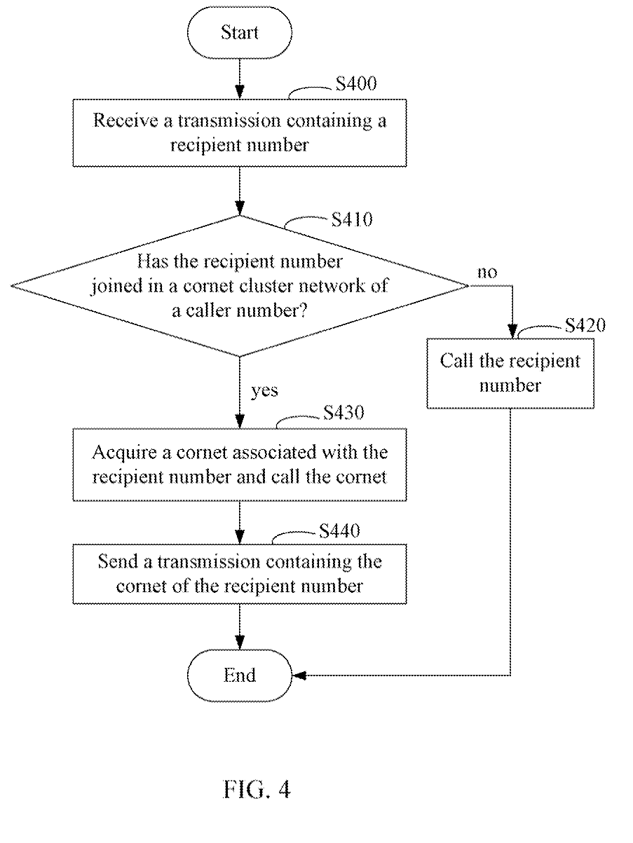

FIG. 4 is a flowchart of a transmission method according to an embodiment, used in the wireless communication service system such as, for example, that of FIG. 1. In step S400, the wireless communication service system 2 receives a transmission containing a recipient number from the mobile phone 1. In step S410, the wireless communication service system 2 determines whether the recipient number has joined the cornet cluster network of the caller number of the mobile phone 1. If not, in step S420, the wireless communication service system 2 calls the recipient number and establishes a communication link with a recipient, and the charge subsystem accounts call charges based on the standard charge operation for each party.

If so, in step S430, the wireless communication service system 2 acquires an associated cornet corresponding to the recipient number, calls the associated cornet, and establishes a communication link with the recipient, and the charge subsystem accounts call charges based on the cornet charge operation for each party. In step S440, the wireless communication service system 2 sends a transmission containing the cornet of the recipient number to the mobile phone 1, and the process is complete.

It is understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A mobile phone, the phone number of which has joined a cornet cluster network in a wireless communication service system, comprising:
an input unit generating a calling signal of a recipient number in response to user input;
a communication unit communicating with the wireless communication service system;
a storage unit storing at least one recipient number and an associated cornet of the recipient number in the cornet cluster network; and
a processing unit determining whether the storage unit comprises a cornet associated with a recipient number based on the calling signal of the recipient number from the input unit; and, if so, acquiring the cornet and directing the communication unit to transmit the cornet; and, if not, directing the communication unit to transmit the recipient number.

2. The mobile phone as recited in claim 1, wherein the processing unit further determines whether the communication unit has received a transmission containing a cornet of the recipient number; and, if so, the processing unit further acquires the cornet of the recipient number and stores the cornet in the storage unit.

3. The mobile phone as recited in claim 1, further comprising a display unit displaying the cornet of the recipient number.

4. A dialing method adapted for a mobile phone comprising:
generating a calling signal of a recipient number;
determining whether a cornet of the recipient number has been stored;
if the cornet of the recipient number has been stored, acquiring the cornet and sending a transmission containing the cornet; and
if the cornet of the recipient number has not been stored, sending a transmission containing the recipient number.

5. The dialing method as recited in claim 4, further comprising, if a cornet of the recipient number has not been stored,
determining whether a transmission containing a cornet of the recipient number has been received; and
if a transmission containing a cornet of the recipient number has been received, acquiring the cornet, storing the cornet and the associated recipient number, and displaying the cornet.

6. A wireless communication service system comprising:
a charge subsystem, accounting call charges for each party and storing a cornet charge operation for cornet customers and a standard charge operation for standard customers; and
at least one cornet cluster network, storing at least one phone number of a mobile phone and an associated cornet;
wherein the wireless communication service system determines whether a recipient number has joined a cornet cluster network of a caller number when the wireless communication service system receives a transmission containing the recipient number;
if the recipient number has joined the cornet cluster network of the caller number, the wireless communication service system acquires a cornet associated with the recipient number, calls the cornet of the recipient number, and establishes a communication link, and the charge subsystem accounts call charges based on the cornet charge operation for each party; and
if the recipient number has not joined the cornet cluster network of the caller number, the wireless communication service system calls the recipient number and establishes a communication link, and the charge subsystem accounts call charges based on the standard charge operation for each party.

7. The wireless communication service system as recited in claim 6, wherein when the recipient number has joined the cornet cluster network of the caller number, the wireless communication service system sends a transmission containing a cornet of the recipient number to the mobile phone.

8. The wireless communication service system as recited in claim 6, wherein both a caller and a recipient pay a first predetermined charge monthly for free use of the cornet charge operation, and the standard charge operation charges based on a call time such as a second predetermined charge per minute for each party.

9. A transmission method adapted for a wireless communication service system, wherein the wireless communication service system comprises a charge subsystem, for accounting call charges for each party and storing a cornet charge operation for cornet customers and a standard charge operation for standard customers, and at least one cornet cluster network, for storing at least one phone number of a mobile phone and an associated cornet, the method comprising:
receiving a transmission containing a recipient number;
determining whether the recipient number has joined the cornet cluster network of a caller number of the mobile phone;
if the recipient number has joined the cornet cluster network of the caller number, acquiring a cornet associated with the recipient number, calling the cornet, and establishing a communication link, and accounting call charges based on the cornet charge operation for each party; and
if the recipient number has not joined the cornet cluster network of the caller number, calling the recipient number and establishing a communication link, and accounting call charges based on the standard charge operation for each party.

10. The transmission method as recited in claim 9, further comprising, if the recipient number has joined the cornet cluster network of the caller number, sending a transmission containing a cornet of the recipient number to the mobile phone.

11. The transmission method as recited in claim 9, wherein both a caller and a recipient pay a first predetermined charge monthly for free use of the cornet charge operation, and the standard charge is based on a call time such as a second predetermined charge per minute for each party.
